(19) United States
(12) Patent Application Publication
(10) Pub. No.: US 2005/0151922 A1
(43) Pub. Date: Jul. 14, 2005

(54) Eyeglasses with living hinge

(76) Inventor: Nonu Ifergan, Mont-Royal (CA)

Correspondence Address: Blake, Cassels & Graydon LLP;Commerce Court West, Box 25, 199 Bay Street, Toronto, ON, M5L 1A9, CA

(21) Appl. No.: 11/020,568

(22) Filed: Dec. 27, 2004

Related U.S. Application Data
(60) Provisional application No. 60/532,174, filed on Dec. 24, 2003.

(51) Int. Cl. G02C 1/00; G02C 9/00

(52) U.S. Cl. 351/41

(57) ABSTRACT

A hinge assembly and an eyeglass utilizing such a hinge assembly is provided. The hinge assembly interconnects a frame of the eyeglass and a temple of the eyeglass. The hinge assembly has an arm extending from the frame, a link extending from the arm and connected to a hinge block that is pivotally connected to the temple. The link is made of a flexible material which permits flexure of the temple relative to the frame. The link is preferably made of a copper aluminum alloy and is also preferably of a circular cross-section. An auxiliary frame may also be attached to the arm of the hinge assembly by magnetic attraction.

This application claims priority from U.S. Provisional Patent Application No. 60/532,174 filed on Dec. 24, 2003.

### BACKGROUND OF THE INVENTION

1. Field of the Invention

The present invention relates to eyeglasses.

2. Description of the Prior Art

Eyeglasses are of course well known and typically comprise a pair of lenses supported within a frame. The frame is connected to temples which are rearwardly directed legs that engage the ears of the user to support the eyeglasses on the user.

The alignment of the frame is important for the utility and comfort of the user of the eyeglasses and therefore the frame must be sufficiently robust to withstand the normal loads placed on it. More recently, it has become common practice to support auxiliary lenses in front of the primary lenses of the spectacles to provide protection under certain conditions, particularly sun light. The auxiliary lenses have been attached with mechanical clips but these are relatively difficult to engage and often require both hands to ensure that they are correctly located. In U.S. Pat. No. 5,568,207 to Chao, there is disclosed the concept of utilising magnets acting between the auxiliary and primary frames to secure the auxiliary frames on the primary frames. Such arrangements are far more convenient allowing attachment and detachment of the lenses.

The magnetic attachment is typically located at the temple region where the magnets may be hidden by the hinge structure used to connect the main frame to the temples. However, the temple region is also the location that is subject to distortion as a result of loads imposed from normal use of the spectacles. For example, in folding the temples, loads are placed on the temple region, and upon placement of the spectacles or adjustment of the spectacles on the user there is a tendency to cause a corresponding displacement of the temple region. This displacement in the temple region may result in dislodgement of the auxiliary eyeglass or require additional connection between the auxiliary eyeglass and the primary frame.

It is therefore an object of the present invention to obviate or mitigate the above disadvantages.

### SUMMARY OF THE INVENTION

In one aspect, the present invention provides a hinge assembly for interconnecting a temple and a frame of an eyeglass comprising an arm secured to the frame at a first end, a flexible link extending between a second end of the arm and a hinge block pivotally connected to the temple. The link is made from a flexible material to permit flexure of the temple relative to the frame.

In another aspect, the present invention provides an eyeglass comprising a frame and a pair of temples interconnected by respective hinge assemblies, each of the hinge assemblies comprising an arm secured to the frame at a first end, a flexible link extending between a second end of the arm and a hinge block pivotally connected to the temple. The link is made from a flexible material to permit flexure of said temple relative to said frame.

In yet another aspect, a corresponding arm of an auxiliary fame is secured to the arm of the eyeglass by magnetic attraction.

### BRIEF DESCRIPTION OF THE DRAWINGS

These and other features of the preferred embodiments of the invention will become more apparent in the following detailed description in which reference is made to the appended drawings wherein:

FIG. 1 is a partial perspective view of eyeglasses incorporating auxiliary frames.

FIG. 2 is a view on the line II-II of FIG. 1.

FIG. 3 is a view in the direction of arrow III of FIG. 1.

FIG. 4 is a view on the line IV of FIG. 1.

FIG. 5 is a view similar to FIG. 1 of an alternative embodiment of eyeglass.

FIG. 6 is a view similar to FIG. 1 of a still further embodiment of eyeglass.

FIG. 7 is a perspective view from above of the eyeglasses of FIG. 6 in an alternative configuration.

FIG. 8 is an exploded view of an alternative arrangement of the eyeglasses of FIG. 1.

### DESCRIPTION OF THE PREFERRED EMBODIMENTS

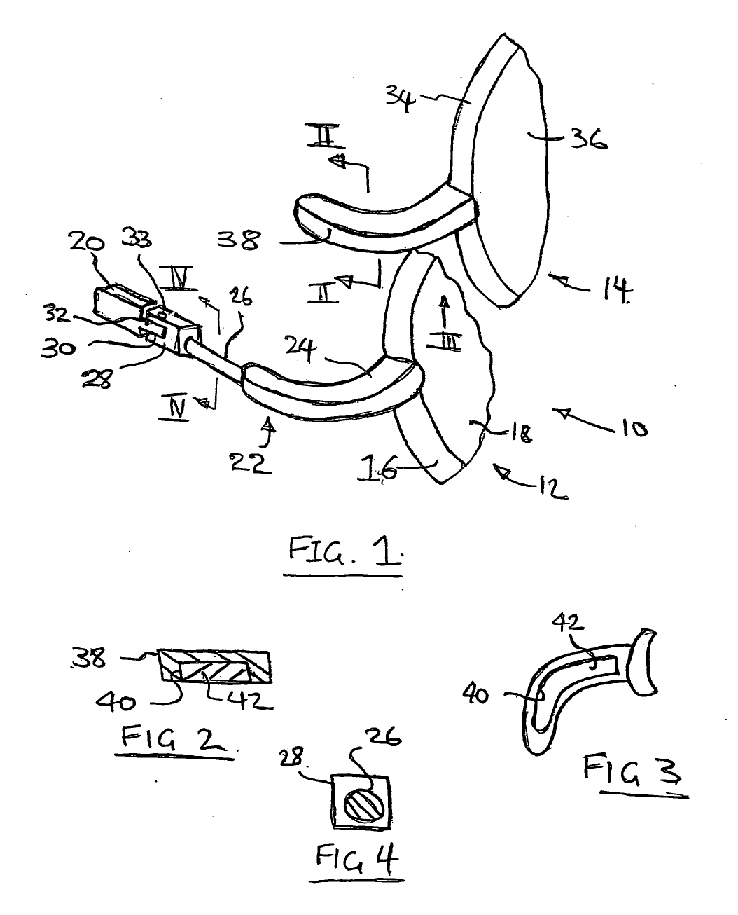

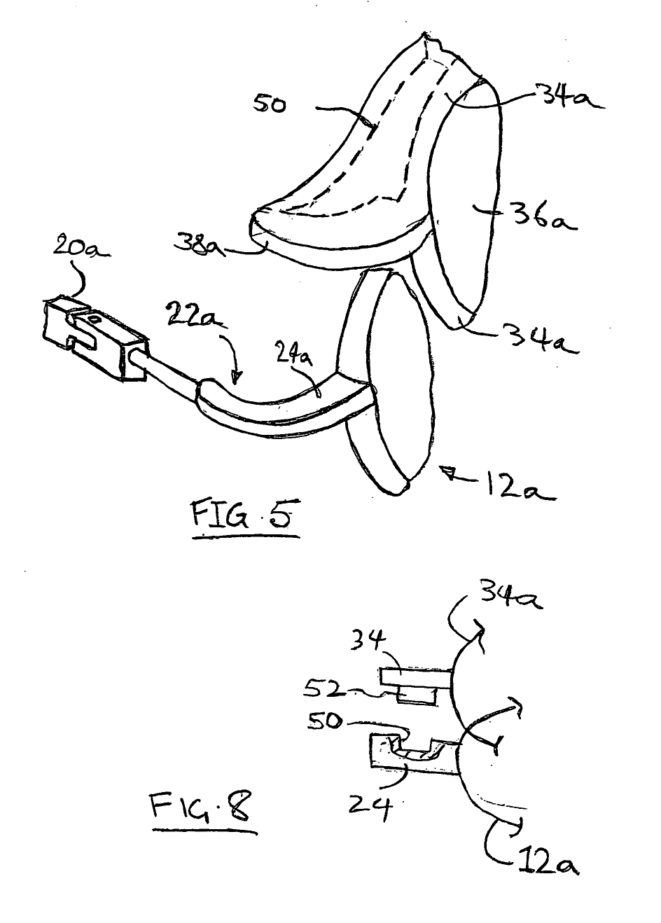

Referring therefore to FIG. 1, eyeglasses generally indicated by numeral 10 include a primary free assembly 12 and an auxiliary lens assembly 14. The primary frame assembly 12 includes a frame 16 and lenses 18 secured within the frame 16. It will be appreciated that there are a pair of lenses 16 located within the frame which extends across the nasal region of the wearer. However, such construction is well known and it is believed unnecessary to describe in further detail.

Temples 20 extend rearwardly from the primary frame 12 and are connected to the primary frame through a hinge structure generally indicated by numeral 22. The hinge structure 22 includes an arm 24 secured to the side of the main frame 16. The arm 24 curves rearwardly and is connected to a flexible link 26. The link 26 is made from a shape memory alloy, preferably made from a shape memory alloy offering flexibility and high shape recovery factor. Suitable materials are a nickel-titanium alloy or a copper aluminum alloy, such as those disclosed in U.S. Pat. No. 5,140,217, the contents of which are incorporated herein by reference. As can been seen in FIG. 4, the link 26 is circular in cross section and extends between the terminal portion of the arm 24 and a hinge block 28. The link 26 is secured in the arm 24 and block 28 by an adhesive or other suitable means.

Thy hinge block is formed with a clevis 30 to receive a tongue 32 formed at the end of the temples 20. A screw 33 passes through the tongue and clevis to provide a pivot axis for the temple 20 relative to the main frame 16.

The auxiliary lens assembly 14 similarly includes a frame 34 to secure the auxiliary lenses, which is of complimentary shape to the frame 16 so that the lenses 36 overly the lenses 18. A support arm 38 is secured to the frame 34 and is dimensioned to be of complimentary shape to and overlie the arm 24. A cavity 40 is formed on the underside of the arm 38 to receive an L-shaped magnet 42 which generally conforms to the shape of the arm 38.

In use, the arm 38 is positioned over the arm 24 such that the magnet 42 abuts the upper surface of the arm 24. The magnet 42 is attracted to the arm 24 that is made from magnetisable material and holds the auxiliary lens 14 in situ. The temples 20 may pivot about the screw 33 for storage but when placed on the user, the link 26 permits flexure of the temple relative to the main frame. The circular cross section of the link 26 provides equal flexure of the link 26 in all directions and so can accommodate loads imposed on the frame by external influences. The flexure of the link 26 thus maintains the stability of the arm 24 and avoids displacement of the arm 24 relative to the support arm 38.

Naturally, the link 26 also accommodates flexure during storage and assists in maintaining the alignment of the eyeglass assembly 10. If preferred, the arm 24 may have a magnet embedded within it for engagement with magnet of the arm 34, or the arm 34 may be made from a magnetic material for retention by a magnet in the arm 24. In each embodiment, the arms 34 is retained on the arm 24 by magnetic attraction. As a further option as shown in FIG. 8, a socket may be formed on one of the arms 24, 34 and a protrusion 52 on the other to assist in locating the frame assemblies. It is preferred that the protrusion is a magnet and the socket is magnetic.

An alternative embodiment of eyeglass is shown in FIG. 5 in which like reference numerals will be used to identify like components with a suffix “a” added for clarity. In the arrangement of FIG. 5, the primary frame assembly 12a and hinge assembly 22a are the same as that shown in FIG. 1. The auxiliary lens assembly 14a has a frame 34a from which an arm 38a projects. The frame 34a includes a shroud 50 that projects rearwardly from the auxiliary lens 36a toward the user. The shroud smoothly merges with the arm 38a to provide a closely fitting shield to prevent the ingress of incident light around the primary frame assembly 12a. The arm 38a is secured to the arm 24a by interaction of magnets as described above.

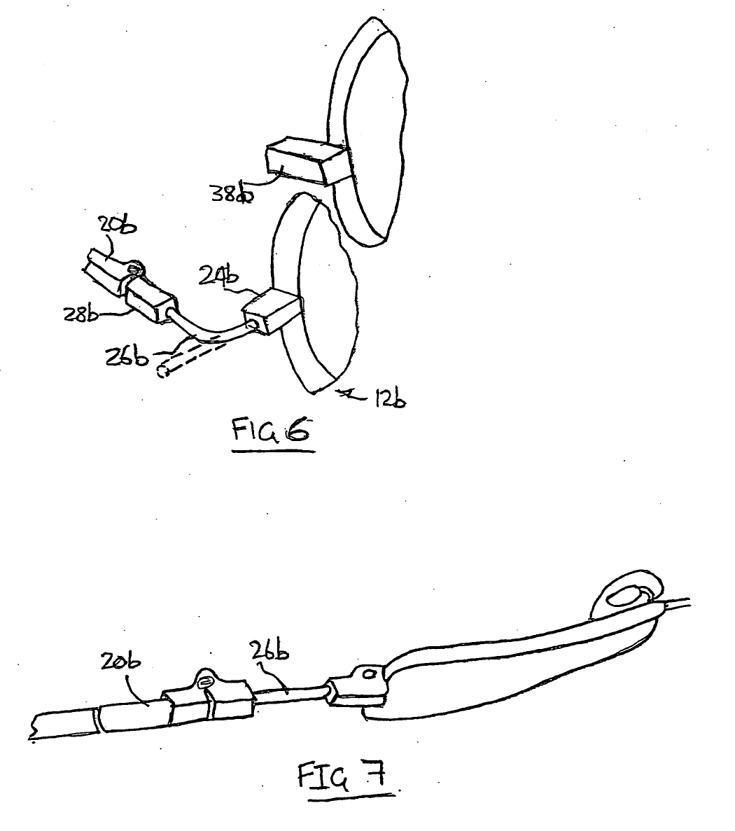

A further embodiment of eyeglass is shown in FIGS. 6 and 7 where like components will be identified with like reference numerals and a suffix “b” added for clarity. In the embodiment of FIGS. 6 and 7 the arm 24b is formed as a lateral projection and the arm 38b similarly formed as a rearwardly extending projection. Link 26b extends from the block 28b to the arm 24b and is bent through a right angle in a free body state. This places the temples in the correct orientation when in use on the user whilst permitting flexure to accommodate minor variations. The link 26b is circular in cross section thereby allowing uniform flexure to accommodate distortion between the temple 20b and the main frame 12b. As may be seen in FIG. 7, which shows the configuration with an external load applied to the temples, the link 26b is sufficiently flexible to allow the temple 20b to extend laterally from the main frame 12b and to return to a right angle after the load is removed. Again, the magnet is accommodated in the under surface of the arm 38b so as to be engageable with the upper surface of the extension 24b.

In each embodiment, flexibility is provided between the main frame and the hinge to accommodate external loads and maintain alignment on the user. At the same time, a relatively simple hinge may be used and a stable location is provided for attachment of the auxiliary frames.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A hinge assembly for interconnecting a temple and a frame of an eyeglass comprising an arm to be secured to said frame at a first end, a flexible link extending between a second end of said arm and a hinge block for pivotal connection to said temple, said link being made from a flexible material to permit flexure of said temple relative to said frame.

2. A hinge assembly according to claim 1 wherein said arm is arcuate between said first and second ends.

3. A hinge assembly according to claim 2 wherein said arm is linear.

4. A hinge assembly according to claim 3 wherein said link is arcuate.

5. A hinge assembly according to claim 4 wherein said link extends through 90° in a free body state.

6. A hinge assembly according to claim 5 wherein said link is circular in cross section.

7. A hinge assembly according to claim 1 wherein said flexible material is a shape memory alloy.

8. A hinge assembly according to claim 7 wherein said arm is made of a magnetic material.

9. A hinge assembly according to claim 7 wherein said arm has a magnetic member.

10. A hinge assembly according to claim 5 wherein said shape memory alloy is selected from the group comprising nickel titanium alloys and copper aluminum alloys.

11. A hinge assembly according to claim 1 wherein said link is circular in cross-section.

12. An eyeglass comprising a primary frame and a pair of temples interconnected by respective hinge assemblies, each of said hinge assemblies comprising an arm secured to said primary frame at a first end, a flexible link extending between a second end of said arm and a hinge block pivotally connected to said temple, said link being made from a flexible material to permit flexure of said temple relative to said frame.

13. An eyeglass according to claim 12 wherein said arm curves rearwardly from said frame.

14. An eyeglass according to claim 12 wherein said arm extends laterally from said frame.

15. An eyeglass according to claim 14 wherein said link curves rearwardly from said arm when said eyeglass is in use.

16. An eyeglass according to claim 12 wherein said hinge block is formed with a clevis to receive a tongue formed at the end of said temple.

17. An eyeglass according to claim 12 wherein said hinge block is rectangularly shaped.

18. An eyeglass according to claim 12 wherein said link is made of a shape memory alloy.

19. An eyeglass according to claim 12 wherein said link is circular in cross-section.

20. An eyeglass according to claim 12 including an auxiliary frame disposed in front of said primary frame and having a rearwardly extending support aim, said support arm of said auxiliary frame being secured arm or said primary frame by magnetic attraction.

21. An eyeglass according to claim 20 wherein said arm of said primary frame is made of a magnetic material.

22. An eyeglass according to claim 20 wherein said arm includes a magnetic member.

23. An eyeglass according to claim 20 wherein said support arm of said auxiliary frame is made of a magnetic material.

24. An eyeglass according to claim 20 wherein said support arm of said auxiliary frame has a magnetic member.

25. An eyeglass according to claim 24 wherein said magnetic member is embedded in said support arm.

26. An eyeglass according to claim 25 wherein said magnetic member conforms to the shape of said support arm.

27. An eyeglass according to claim 20 wherein said auxiliary frame has a shroud projecting rearwardly therefrom.

28. An eyeglass according to claim 27 wherein said shroud merges smoothly with said support arm to provide a closely fitting shield to prevent the ingress of incident light around said frame of said eyeglass.
